(19) United States
(12) Patent Application Publication
(10) Pub. No.: US 2002/0030959 A1
(43) Pub. Date: Mar. 14, 2002

(54) Hands-free control device for protection against electrostatic discharges

(76) Inventor: Samira Abderrahim Soares, Madrid (ES)

Correspondence Address: CROWELL & MORING, L.L.P., P.O. BOX 14300, Washington, DC, 20044-4300, US

(21) Appl. No.: 09/921,247

(22) Filed: Aug. 3, 2001

(30) Foreign Application Priority Data
Aug. 14, 2000 (ES) 200002149

(51) Int. Cl. H01H 47/00

(52) U.S. Cl. 361/220; 361/232

(57) ABSTRACT

A HANDS-FREE device is provided to protect against electrostatic discharges. Ths device is formed by a band, preferably rectangular, of a semiconducting flexible material. The band or strip has on the area of one end thereof a clip for attachment to a garment worn by the user, while also attached to this clip is the end of an electrical cable that is connected to an electrical connection box that is grounded.

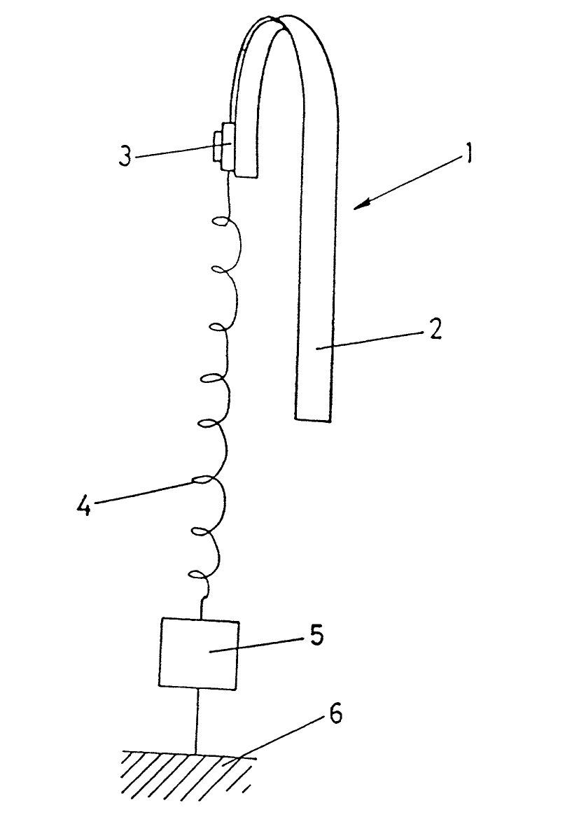

### BACKGROUND OF THE INVENTION

The present invention relates to a HANDS-FREE device for protection against electrostatic discharges, particularly applicable to the field of eleccronics and microelectronics, where the greatest danger is electrostatic discharges that can totally or partially damage components sensitive to discharges, giving rise to their destruction or causing equipment to malfunction.

Ways are currently known to protect electrical and electronic apparatus and equipment from electrostatic discharges, but in the majority of cases these ways of protection offer a very important problem for the person operating such apparatus and/or equipment.

### SUMMARY OF THE INVENTION

The device of the present invention serves to connect the skin of the user to earth and thus control electrostatic discharges in the protected areas.

As is already known, an electrostatic discharge is the transfer of a static charge between bodies with different electrostatic potentials, in direct contact or induced. An example of this is what occurs with lightning, which is the spark that is produced between the clouds and the land surface due to the difference in electrostatic potential, or the discharge that a person receives when leaving a automobile which is the spark that occurs between the vehicle and the human body due to the difference in electrostatic potential between the two.

The device of the invention consists of a trip or band of semiconducting material on which is mounted a molding clip from which hangs a cable connected to a connection box and this latter to ground.

The clip may be a peg, brooch, etc. of the sort that allows this attachment system to easily fix the device on any part of a garment worn by rhe person operating the apparatus or equipment to be protected.

### BRIEF DESCRIPTION OF THE DRAWING

Other objects, advantages and novel fea1ures of the present invention will become apparent from the following detiailed description of the invention when considered in conjunction with the accompanying drawings.

The sole drawing is a schematic view of the complete device of the invention, including its connection to ground

### DESCRIPTION OF DRAWING

A band of semiconducting material is designated generally by numeral 2. One end of the band 2 has a clip 3 of conventional construction affixed thereto that allows a person to attach and remove the device to and from the garment that person is wearing. The band is constructed with the characteristics similar to wrist bands in accordance with EN-100015. A European standard for the protection electronic devices from electrostatic discharge (ESD) phenomena. Typically, the hand has an electrical resistance of less than 10 mega ohms.

Mounted on the clip 3 is the end of an electrical cable 4 which is connected at its other end to an electrical connection box 5 that is grounded at 6. The box typically has an internal resistance of 1 ohm in order that the sum of the impedance and the band resistance is less than 10⁵ mega ohms.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. HANDS-FREE device to protect against electrostatic discharges comprising a band of semiconducting flexible material, a clip arranged on an end area of the band for attaching the band to a user's garment, and an electrical cable operatively connected to thle clip and to a grounded electricaL connection box.
